(19) United States
(12) Patent Application Publication
(10) Pub. No.: US 2024/0125992 A1
(43) Pub. Date: Apr. 18, 2024

(54) OPTICAL FILTER FOR MULTISPECTRAL SENSOR

(71) Applicants: STMicroelectronics (Crolles 2) SAS, Crolles (FR); COMMISSARIAT A L'ENERGIE ATOMIQUE ET AUX ENERGIES ALTERNATIVES, Paris (FR)

(72) Inventors: Quentin ABADIE, Grenoble (FR); Sandrine VILLENAVE, Grenoble (FR)

(73) Assignees: STMicroelectronics (Crolles 2) SAS, Crolles (FR); COMMISSARIAT A L'ENERGIE ATOMIQUE ET AUX ENERGIES ALTERNATIVES, Paris (FR)

(21) Appl. No.: 18/191,550

(22) Filed: Mar. 28, 2023

(30) Foreign Application Priority Data
Oct. 12, 2022 (FR) 2210453

(51) Int. Cl. G02B 5/28; G01J 3/28

(52) U.S. Cl. CPC G02B 5/288; G01J 3/2823; G01J 2003/2826

(57) ABSTRACT

The present description concerns an optical filter intended to be arranged in front of an image sensor comprising a plurality of pixels, the filter comprising, for each pixel, a resonant cavity comprising a first transparent layer, interposed between second and third mirror layers, and a diffraction grating formed in the first layer, wherein at least one of the cavities has a different thickness than another cavity.

### CROSS-REFERENCE TO RELATED APPLICATION(S)

This application claims the priority benefit of French patent application number 2210453, filed on Oct. 12, 2022, entitled “Filtre optique pour capteur multispectral,” which is hereby incorporated by reference to the maximum extent allowable by law.

### TECHNICAL FIELD

The present disclosure generally concerns multispectral sensors adapted to acquiring images of a scene in different wavelength ranges. The present disclosure more particularly aims at an optical filter for a multispectral filter, a multispectral filter comprising such a filter, and a method of manufacturing an optical filter for a multispectral sensor.

### DESCRIPTION OF THE RELATED ART

Multispectral sensors comprising a filter wheel placed in front of a sensor adapted to acquiring an image for each filter of the wheel have been provided. Other more compact multispectral sensors comprising a single optical filter arranged in front of an image sensors, the filter being adapted to transmitting an incident radiation mainly in a first wavelength range towards certain pixels of the sensor and mainly in at least a second wavelength range, different from the first wavelength range, towards other pixels of the sensor, have further been provided.

These multispectral sensors however suffer from various disadvantages. It would in particular be desirable to have compact multispectral sensors having both a wide spectral band and a high resolution.

### BRIEF SUMMARY

An object of an embodiment is to overcome all or part of the disadvantages of known optical filters for a multispectral sensor, of known multispectral sensors integrating such filters, and of known methods of manufacturing optical filters for a multispectral sensor.

For this purpose, an embodiment provides an optical filter intended to be arranged in front of an image sensor comprising a plurality of pixels, the filter comprising, for each pixel, a resonant cavity comprising a first transparent layer, interposed between second and third mirror layers, and a diffraction grating formed in the first layer, wherein at least one of the cavities has a different thickness than another cavity.

According to an embodiment, the filter comprises a plurality of groups of adjacent resonant cavities of same thickness different from those of the resonant cavities forming part of the groups of resonant cavities adjacent to said group.

According to an embodiment, each group comprises exactly four adjacent resonant cavities of same thickness.

According to an embodiment, the filter comprises a plurality of assemblies of non-adjacent groups of resonant cavities of same thickness arranged according to a regular pattern, the resonant cavities of each assembly having a thickness different from that of the resonant cavities of the other assemblies.

According to an embodiment, each resonant cavity has a thickness different from that of the resonant cavities adjacent to said cavity.

According to an embodiment, the diffraction grating of each resonant cavity has a filling factor different from those of the diffraction gratings of the resonant cavities adjacent to said cavity.

According to an embodiment, the diffraction grating of each resonant cavity comprises a plurality of regions made of a material having a refraction index greater than that of the first transparent layer.

According to an embodiment, each region has the shape of a pad.

According to an embodiment, each region has the shape of strip.

According to an embodiment, the first transparent layer comprises:
a first portion made of a first material, vertically extending from the second mirror layer to the regions; and
a second portion made of a second material, different from the first material, the second portion laterally extending between the regions and vertically extending from the first portion to the third mirror layer.

An embodiment provides a multispectral image sensor comprising an image sensor comprising a plurality of pixels formed inside and on top of a semiconductor substrate and an optical filter such as described.

An embodiment provides a method of manufacturing an optical filter intended to be arranged in front of an image sensor comprising a plurality of pixels, the method comprising the following successive steps:
a) depositing a first transparent layer coating a second mirror layer;
b) forming, in the first transparent layer, a diffraction grating; and
c) depositing a third mirror layer coating the first transparent layer,
   wherein the first transparent layer and the second and third mirror layers form, for each pixel, a resonant cavity, at least one of the cavities having a different thickness than another cavity.

According to an embodiment, the diffraction grating is formed from a fourth layer having a refraction index greater than that of the first transparent layer.

According to an embodiment, the first transparent layer is formed by successive depositions:
of a first portion of a first material, vertically extending from the second mirror layer to the diffraction grating; and
of a second portion of a second material, different from the first material, the second portion vertically extending from the first portion to the third mirror layer.

According to an embodiment, the third mirror layer comprises at least two portions made of different materials.

### BRIEF DESCRIPTION OF THE SEVERAL VIEWS OF THE DRAWINGS

The foregoing and other features and advantages of the present disclosure will be discussed in detail in the following non-limiting description of specific embodiments in connection with the accompanying drawing, in which:

FIG. 1 is a simplified and partial cross-section view of an example of a multispectral image sensor comprising an optical filter according to an embodiment;

FIG. 2A, FIG. 2B, FIG. 2C, FIG. 2D, FIG. 2E, and FIG. 2F are cross-section views illustrating, in simplified and partial fashion, successive steps of an example of a method of manufacturing the device of FIG. 1 according to an embodiment; and

FIG. 3A and FIG. 3B are cross-section views schematically and partially illustrating successive steps of a variant of the method of manufacturing the device of FIG. 1.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the forming of the photodiodes and of the pixel control circuits has not been detailed, the forming of such pixels being within the abilities of those skilled in the art based on the indications of the present disclosure.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front,” “back,” “top,” “bottom,” “left,” “right,” etc., or relative positions, such as terms “above,” “under,” “upper,” “lower,” etc., or to terms qualifying directions, such as terms “horizontal,” “vertical,” etc., it is referred, unless specified otherwise, to the orientation of the drawings.

Unless specified otherwise, the expressions “about,” “approximately,” “substantially,” and “in the order of” signify plus or minus 10%, preferably of plus or minus 5%.

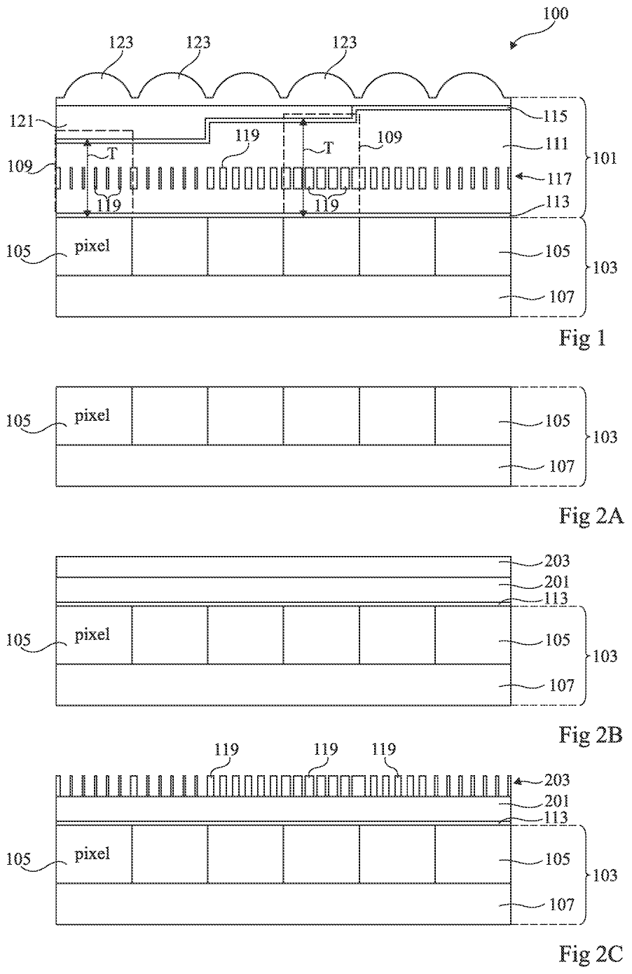

FIG. 1 is a simplified and partial cross-section view of an example of a multispectral image sensor 100 comprising an optical filter 101 according to an embodiment.

In the shown example, optical filter 101 is arranged in front of an image sensor 103, for example, a CMOS (“Complementary Metal-Oxide-Semiconductor”) sensor. Sensor 103 comprises a plurality of pixels 105 formed inside and on top of a substrate 107, for example, a wafer or a piece of wafer made of a semiconductor material, for example, silicon. Pixels 105 are for example arranged in an array along rows and columns. Each pixel 105 of sensor 103 has for example, in top view, a rectangular or square shape. Although this has not been detailed in FIG. 1, control and readout circuits of the pixels 105 of sensor 103 may further be formed inside and on top of substrate 107. Further, although six pixels 105 only have been illustrated in FIG. 1, image sensor 103 may of course comprise a much larger number of pixels 105, for example, several thousands or several millions of pixels 105.

According to an embodiment, the optical filter 101 intended to be arranged in front of image sensor 103 comprises, for each pixel 105 of sensor 103, a resonant cavity 109 comprising a first transparent layer 111, for example, an electrically-insulating layer, interposed between second and third mirror layers 113 and 115. Layer 111 is transparent in the operating wavelength range of optical filter 101. Further, at least one of the cavities 109 of optical filter 101 has a thickness T different from another cavity 109. Each resonant cavity 109 for example has, in top view, a rectangular or square shape, for example, identical to the shape of the underlying pixel 105. Further, each resonant cavity 109 for example has lateral dimensions substantially equal to those of the underlying pixel 105.

As an example, the resonant cavities 109 of optical filter 101 are Fabry-Perot cavities.

Optical filter 101 may, as in the example illustrated in FIG. 1, comprise a plurality of groups of adjacent resonant cavities 109, the resonant cavities 109 of a same group having a same thickness T, to within manufacturing dispersions, and being respectively located in front of adjacent pixels 105 of image sensor 103. As an example, filter 101 may comprise groups of four adjacent resonant cavities 109 of same thickness T respectively located in front of four adjacent pixels 105, the group of adjacent resonant cavities 109 for example having, in top view, a substantially square-shaped periphery. The thickness T of resonant cavities 109 forming part of a same group is different from the thicknesses T of the resonant cavities 109 forming part of the groups of cavities 109 adjacent to the considered group. The resonant cavities 109 of a same group for example form a single resonant cavity of thickness T.

As a variant, each resonant cavity 109 located in front of one of the pixels 105 of sensor 103 has a thickness T different from the thicknesses T of the resonant cavities 109 located in front of the pixels 105 of sensor 103 adjacent to the considered pixel 105, that is, a thickness T different from those of the resonant cavities 109 adjacent to the considered cavity. In other words, the resonant cavities 109 located in front of two adjacent pixels 105 have, in this variant, different thicknesses T.

As an example, the pixels 105 of sensor 103 have maximum lateral dimensions smaller than 4 μm, for example in the range from 1 to 2 μm, in the case where the resonant cavities 109 are distributed in groups of adjacent cavities of same thickness T, and in the range from 4 to 10 μm, for example, in the order of 5 μm, in the case where the resonant cavities 109 located in front of two adjacent pixels 105 have different thicknesses T.

Optical filter 101 may comprise a plurality of assemblies, for example, from two to ten assemblies, each comprising a plurality of non-adjacent cavities or groups of resonant cavities 109 of same thickness T, to within manufacturing dispersions. The thickness T of the resonant cavities 109 forming part of a same assembly is different from the thicknesses T of the resonant cavities 109 forming part of the other assemblies. The resonant cavities 109 or the groups of resonant cavities 109 forming part of a same assembly are for example arranged according to a regular pattern.

Each cavity 109 of filter 101 is mainly resonant for a wavelength range of an incident radiation intended to be transmitted to a photosensitive area of the underlying pixel 105. The wavelength range transmitted by each resonant cavity 109 is, among others, a function of the thickness T of the considered cavity 109 (the larger the thickness T of resonant cavity 109, the higher the wavelength of the radiation mainly transmitted to the underlying pixel 105). Thus, the fact of providing resonant cavities 109 or groups of resonant cavities 109 of different thicknesses T enables filter 101 to transmit the incident radiation in different wavelength ranges and to cover a wide spectral band for example extending over several hundreds of nanometers in a case where the limiting thicknesses T are separated by several tens of nanometers.

According to an embodiment, each resonant cavity 109 of optical filter 101 further comprises a diffraction grating 117 formed in first layer 111.

In the shown example, the diffraction grating 117 of each resonant cavity 109 comprises a plurality of regions 119 made of a material different from that of transparent layer 111, regions 119 being separated from one another by portions of transparent layer 111. Regions 119 are for example separated from mirror layers 113 and 115 by other portions of transparent layer 111.

Each region 119 for example has the shape of a pad vertically extending across the thickness of layer 111. The pads may in this case have, in top view, a cross-section having any shape, for example, circular, rectangular, or square. As a variant, regions 119 may be strips parallel to one another, for example laterally extending between two opposite sides of optical filter 101 along a direction orthogonal to the cross-section plane of FIG. 1.

In the shown example, regions 119 have a same height, or thickness, that is, a same dimension according to a direction orthogonal to mirror layers 113 and 115.

Regions 119 for example form a grating having a pitch substantially constant across the entire filter 101, the pitch of the grating corresponding to a center-to-center distance between two neighboring pads or to a distance between two median lines of two neighboring strips. As an example, the pitch of the grating formed by regions 119 is in the order of one hundred or of several hundreds of nanometers, for example, equal to approximately 150 nm. In the shown example, the diffraction grating 117 of each resonant cavity 109 located in front of one of the pixels 105 of sensor 103 has a filling factor different from the filling factors of the diffraction gratings 117 of the resonant cavities 109 located in front of the pixels 105 of sensor 103 adjacent to the considered pixel. In other words, the diffraction gratings 117 of the resonant cavities 109 located in front of two adjacent pixels 105 have different filling factors. In particular, in the example illustrated in FIG. 1 where filter 101 comprises groups of adjacent resonant cavities 109 of same thickness T, the diffraction gratings 117 of the resonant cavities 109 forming part of a same group have different filling factors.

By filling factor of diffraction grating 117, there is meant a ratio of, on the one hand, surface areas or volumes occupied by regions 119 to, on the other hand, surface areas or volumes occupied by the portions of transparent layer 111 laterally extending between regions 119.

In the shown example, the diffraction grating 117 of each resonant cavity 119 of optical filter 101 has, inside of the considered cavity, a substantially constant filling factor. In other words, the regions 119 of diffraction grating 117 are, inside of a same resonant cavity 109, uniformly spaced apart from one another and have substantially identical lateral dimensions.

As an example, gratings 117 are resonant waveguide gratings (RWG), or resonant guided-mode filters.

The wavelength range transmitted by each resonant cavity 109 is a function of, apart from the thickness T of the cavity, the filling factor of diffraction grating 117 (the higher the filling factor of grating 117, the higher the wavelength of the radiation mainly transmitted to the underlying pixel 105). Each resonant cavity 109 has an optical index depending on the material of transparent layer 111, this material being for example identical for all the cavities 109 of optical filter 101, and on the filling factor of the grating 117 of the considered cavity. Thus, the fact of providing resonant cavities 109 having diffraction gratings 117 having different filling factors enables to obtain different optical indexes inside of these cavities, and thus to transmit the incident radiation in different wavelength ranges.

The presence of resonant cavities 109 of different thicknesses T enables optical filter 101 to access a wider spectral band than that which would be obtained by means of a filter only comprising diffraction gratings 117 having different filling factors. Further, the presence of diffraction gratings 117 having different filling factors enables optical filter 101 to have a spectral resolution greater than that which would be obtained by means of a filter only comprising resonant cavities 109 of different thicknesses T, for example due to limits inherent to methods of forming cavities of variable thicknesses.

Further, the fact of providing, as in the example illustrated in FIG. 1, groups of adjacent resonant cavities 109 of same thickness T but having diffraction gratings 117 having, within a same group, different filling factors, enables optical filter 101 to benefit from a spatial resolution greater than that, for example, of optical filter 101 deprived of diffraction gratings 117, for example due to limits inherent to the implemented methods. Thus, the fact of combining, in optical filter 101, resonant cavities 109 of different thicknesses T and, inside of the cavities, diffraction gratings 117 having different filling factors enables to access a wider spectral band or a resolution greater than that of an optical filer comprising only one or the other of these characteristics.

The multispectral sensor 100 integrating filter 101 advantageously has a compactness greater than that of multispectral sensors comprising a filter wheel placed in front of a sensor adapted to acquiring an image for each filter of the wheel while further having a wider spectral band and/or a higher resolution than existing multispectral sensors comprising a filter adapted to transmitting the incident radiation in at least two different wavelength ranges.

In the shown example, sensor 100 further comprises a planarization layer 121 coating mirror layer 115. Layer 121 enables to compensate for the thickness differences T between the cavities 109 of filter 101 to obtain a substantially planar surface (the upper surface, in the orientation of FIG. 1). As an example, layer 121 is made of an organic material, for example, a resin.

In the example illustrated in FIG. 1, sensor 100 further comprises a layer of microlenses 123 coating planarization layer 121. Each microlens 123 is arranged in front of one of the pixels 105 of sensor 103 and for example enables to focus an incident radiation on a photosensitive area of the underlying pixel 105. Microlenses 123 are for example made of the same material as layer 121, for example, of a resin.

As a variation, planarization layer 121 may be omitted. Microlenses 123 then coat mirror layer 115 and at least one of microlenses 123 is located at a height different from that at which another microlens 123 is located due to the difference in thickness T between the cavities 109 of filter 101.

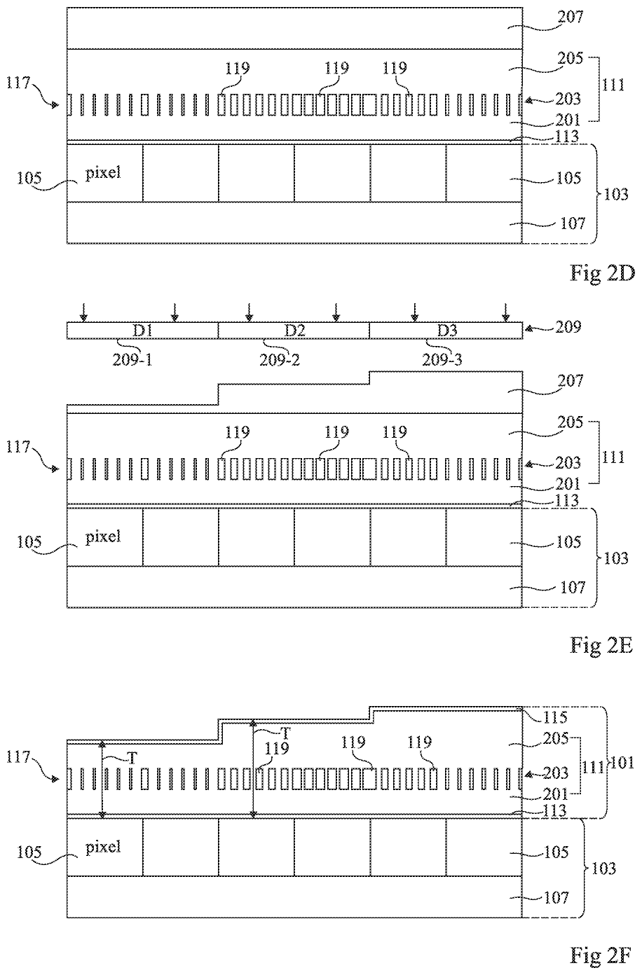

FIG. 2A, FIG. 2B, FIG. 2C, FIG. 2D, FIG. 2E, and FIG. 2F are cross-section views schematically and partially illustrating successive steps of an example of a method of manufacturing the device 100 of FIG. 1.

FIG. 2A more precisely illustrates a structure obtained at the end of the forming of image sensor 103, particularly after the forming of pixels 105 inside and on top of substrate 107.

FIG. 2B more precisely illustrates a structure obtained at the end of successive steps of deposition of mirror layer 113, of a transparent layer 201, for example, an electrically-insulating layer, and of a layer 203 made of a material different from that of transparent layer 201. In the shown example, mirror layer 113 coats a surface of the pixel array 105 opposite to substrate 107 (the upper surface of pixel array 105, in the orientation of FIG. 2B). Mirror layer 113 is coated with transparent layer 201, itself coated with layer 203.

As an example, mirror layer 113 is a thin metal layer, for example, a gold, silver, or aluminum layer, or a layer made of an alloy of one or a plurality of these metals. As a variant, mirror layer 113 is a Bragg mirror comprising a stack of dielectric layers having different refraction indexes.

As an example, transparent layer 201 is made of an oxide, for example, silicon dioxide (SiO₂).

Layer 203 is for example electrically insulating and has a refraction index greater than that of transparent layer 201. As an example, layer 203 is made of silicon nitride (SiN), of amorphous silicon, of titanium dioxide (TiO₂), of alumina (Al₂O₃), or of tantalum pentoxide (Ta₂O₅).

FIG. 2C more precisely illustrates a structure obtained at the end of a step of structuring, for example by photolithography and then etching, of layer 203 so as to form regions 119.

FIG. 2D more precisely illustrates a structure obtained at the end of successive steps of deposition of a transparent layer 205 and of a layer 207 made of a resist. In the shown example, transparent layer 205 closes, or totally fills, all the free spaces laterally extending between the regions 119 previously formed from layer 203 and coats the surfaces of regions 119 opposite to mirror layer 113 (the upper surfaces of regions 119, in the orientation of FIG. 2D). This thus forms diffraction grating 117. In the example illustrated in FIG. 2D, layer 205 is made of the same material as layer 201, layers 201 and 205 jointly forming the transparent layer 111 previously described in relation with FIG. 1. Resist layer 207 coats layer 205, that is, layer 111 in this example.

A planarization step, for example, by chemical and mechanical polishing (CMP), of the upper surface of layer 205 may be implemented prior to the deposition of resist layer 207 to improve its surface condition.

FIG. 2E more precisely illustrates a structure obtained at the end of a step of illumination of the resist of layer 207 through a grey scale optical mask 209, then of a step of development of the resist. In the shown example, mask 209 more precisely comprises three regions 209-1 (D1), 209-2 (D2), and 209-3 (D3) having increasing absorption rates, or increasing optical densities, at the wavelength of the radiation used for the illumination of resin layer 207. Thus, layer 207 is illuminated down to a more significant depth, from its upper surface, in a portion of layer 207 located substantially vertically in line with the region 209-1 of mask 209 than in another portion of layer 207 located vertically in line with the region 209-3 of mask 209, still another portion of layer 207 located vertically in line with the region 209-2 of the mask being illuminated down to an intermediate depth.

After the development, resist layer 207 has, as in the example illustrated in FIG. 2E, an upper stepped surface comprising steps each having, as compared with the adjacent step(s), a height for example in the range from 25 to 50 nm.

As a variant, it may be provided, instead of performing a photolithography through grey scale optical mask 209 followed by an etching of the resin thus insulated, to successively perform a plurality of photolithography and etching steps to obtain the resonant cavities 109 of variable thicknesses T.

FIG. 2F more precisely illustrates a structure obtained at the end of a step of etching, for example, a dry etching of RIE (“Reactive Ion Etching”) type, of layers 205 and 207 and of a subsequent step of deposition of mirror layer 115. The larger the thickness of the layer 207 coating the upper surface of layer 205 and the lower the depth of etching of layer 205, from the upper surface of layer 205. This enables to transfer the relief of the upper surface of layer 207 onto the upper surface of layer 205 and to obtain resonant cavities 109 having different thicknesses T.

In the shown example, mirror layer 115 coats the upper surface of layer 207. Mirror layer 115 for example has a structure and a composition identical or similar to those of mirror layer 113. As an example, mirror layer 115 is made of a material reflective in the entire operating wavelength range of optical filter 101. As a variant, mirror layer 115 comprises at least two portions made of different materials, each portion of mirror layer 115 coating one or a plurality of portions of same thickness of layer 207. This for example enables to modify the composition of mirror layer 115 to optimize the reflection of the radiation according to thickness T and to the filling factor of the diffraction grating 117 of the considered cavity 109.

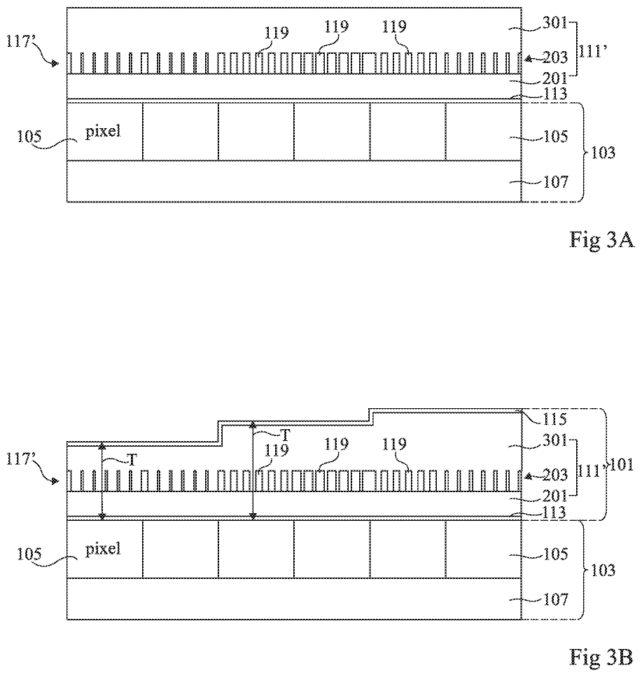

FIG. 3A and FIG. 3B are cross-section views schematically and partially illustrating successive steps of a variant of the method of manufacturing the device 100 of FIG. 1.

This variant of the method of manufacturing device 100 for example comprises initial steps identical or similar to those previously described in relation with FIGS. 2A to 2C.

FIG. 3A more precisely illustrates a structure obtained at the end of a step of deposition, on the upper surface side of the structure of FIG. 2C, of a transparent layer 301 made of a material different from that of layer 201, for example, an electrically-insulating material. Layer 301 is for example made of a resist. In the shown example, transparent layer 301 closes, or totally fills, all the free spaces laterally extending between the regions 119 previously formed from layer 203 and coats the surface of regions 119 opposite to mirror layer 113 (the upper surface of regions 119, in the orientation of FIG. 2D). This thus forms a diffraction grating 117′ similar to diffraction grating 117.

In the example illustrated in FIG. 3A, layers 201 and 301 jointly form a layer 111′ similar to the layer 111 previously described in relation with FIG. 1. In other words, layer 111′ comprises, in this example:
a first portion 201 made of a first material, vertically extending from first mirror layer 113 to regions 119; and
a second portion 301 made of a second material, different from the first material, the second portion laterally extending between regions 119 and vertically extending from the first portion to second mirror layer 115.

FIG. 3B more precisely illustrates a structure obtained at the end of a step of photolithography, through a grey scale mask, followed by an etching of layer 301 to obtain a stepped upper surface similar to that obtained for layer 205 at the end of the steps previously described in relation with FIG. 2F.

An advantage of the variant illustrated in FIGS. 3A and 3B is that it enables, as compared with the method of FIGS. 2A to 2F, to omit the step of deposition of transparent layer 207.

FIG. 3B further illustrates a subsequent step of deposition of mirror layer 115 on the upper surface side of layer 207.

Based on the structure illustrated in FIG. 2F or in FIG. 3B, planarization layer 121 is for example deposited on the upper surface side of mirror layer 115, then planarized, for example by CMP, so that layer 121 has a substantially planar upper surface parallel to mirror layer 113. Microlenses 123 may then be formed on the upper surface side of planarization layer 121.

Various embodiments and variants have been described. Those skilled in the art will understand that certain features of these various embodiments and variants may be combined, and other variants will occur to those skilled in the art. In particular, the manufacturing of optical filter 101 having its mirror layer 115 comprising a plurality of portions made of different materials is within the abilities of those skilled in the art based on the indications of the present disclosure.

Finally, the practical implementation of the described embodiments and variants is within the abilities of those skilled in the art based on the functional indications given hereabove. In particular, those skilled in the art are capable, based on the present description, of determining the thicknesses T and the filling factors of the diffraction gratings 117 of each resonant cavity 109 according to the wavelength ranges to be transmitted to the pixels 105 of the underlying sensor 103.

Optical filter (101) intended to be arranged in front of an image sensor (103) may be summarized as including a plurality of pixels (105), the filter including, for each pixel, a resonant cavity (109) including a first transparent layer (111; 111′), interposed between second and third mirror layers (113, 115), and a diffraction grating (117; 117′) formed in the first layer, wherein at least one of the cavities has a thickness (T) different from another cavity.

Filter, may include a plurality of groups of adjacent resonant cavities (109) of same thickness (T) different from those of the resonant cavities forming part of the groups of resonant cavities adjacent to said group.

Each group may include exactly four adjacent resonant cavities (109) of same thickness (T).

Filter, may include a plurality of assemblies of non-adjacent groups of resonant cavities (109) of same thickness (T) arranged according to a regular pattern, the resonant cavities of each assembly having a thickness different than that of the resonant cavities of the other assemblies.

Each resonant cavity (109) may have a thickness (T) different from that of the resonant cavities (109) adjacent to said cavity.

The diffraction grating (117; 117′) of each resonant cavity (109) may have a filling factor different from those of the diffraction gratings of the resonant cavities adjacent to said cavity.

The diffraction grating (117; 117′) of each resonant cavity (109) may include a plurality of regions (119) made of a material having a refraction index greater than that of the first transparent layer (111; 111′).

Each region (119) may have the shape of a pad.

Each region (119) may have the shape of a strip.

The first transparent layer (111′) may include: a first portion (201) made of a first material, vertically extending from the second mirror layer (113) to the regions (119); and a second portion (301) made of a second material different from the first material, the second portion laterally extending between the regions (119) and vertically extending from the first portion to the third mirror layer (115).

Multispectral image sensor (100) may be summarized as including an image sensor (103) including a plurality of pixels (105) formed inside and on top of a semiconductor substrate (107) and an optical filter (101).

Method of manufacturing an optical filter (101) intended to be arranged in front of an image sensor (103) may be summarized as including a plurality of pixels (105), the method including the following successive steps: a) depositing a first transparent layer (111; 111′) coating a second mirror layer (113); b) forming, in the first transparent layer, a diffraction grating (117; 117′); and c) depositing a third mirror layer (115) coating the first transparent layer, wherein the first transparent layer and the second and third mirror layers form, for each pixel, a resonant cavity (109), at least one of the cavities having a different thickness (T) than another cavity.

At step b), the diffraction grating (117; 117′) may be formed from a fourth layer (203) having a refraction index greater than that of the first transparent layer (111; 111′).

The first transparent layer (111; 111′) may be formed by successive depositions:—of a first portion (201) of a first material, vertically extending from the second mirror layer (113) to the diffraction grating (117; 117′); and—a second portion (301) of a second material, different from the first material, the second portion vertically extending from the first portion to the third mirror layer (115).

The third mirror layer (115) may include at least two portions of different materials.

The various embodiments described above can be combined to provide further embodiments. Aspects of the embodiments can be modified, if necessary to employ concepts of the various patents, applications and publications to provide yet further embodiments.
detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
an image sensor including a plurality of pixels;
an optical filter on the image sensor, the filter including, for each pixel:
a resonant cavity including a first transparent layer, interposed between first and second mirror layers, and a diffraction grating in the first layer, wherein at least one of the cavities has a thickness different from another cavity.

2. The device according to claim 1, comprising a plurality of groups of adjacent resonant cavities of same thickness different from those of the resonant cavities forming part of the groups of resonant cavities adjacent to said group.

3. The device according to claim 2, wherein each group comprises exactly four adjacent resonant cavities of same thickness.

4. The device according to claim 2, comprising a plurality of assemblies of non-adjacent groups of resonant cavities of same thickness arranged according to a regular pattern, the resonant cavities of each assembly having a thickness different than that of the resonant cavities of the other assemblies.

5. The device according to claim 1, wherein each resonant cavity has a thickness different from that of the resonant cavities adjacent to said cavity.

6. The device according to claim 1, wherein the diffraction grating of each resonant cavity has a filling factor different from those of the diffraction gratings of the resonant cavities adjacent to said cavity.

7. The device according to claim 1, wherein the diffraction grating of each resonant cavity comprises a plurality of regions made of a material having a refraction index greater than that of the first transparent layer.

8. The device according to claim 7, wherein each region has the shape of a pad.

9. The device according to claim 7, wherein each region has the shape of a strip.

10. The device according to claim 7, wherein the first transparent layer comprises:
a first portion made of a first material, vertically extending from the first mirror layer to the regions; and
a second portion made of a second material different from the first material, the second portion laterally extending between the regions and vertically extending from the first portion to the second mirror layer.

11. A multispectral image sensor, comprising:
an image sensor including:
a substrate;
a plurality of pixels in and on the substrate; and
an optical filter that includes:
a first mirror layer on the plurality of pixels;
a diffusion grating on the first mirror layer;
a transparent layer on the diffusion grating layer; and
a second mirror layer on the transparent layer, the second mirror layer being spaced from the first mirror layer by a first distance in a first location, the second mirror layer being spaced from the first mirror layer by a second distance in a second location, the second distance being greater than the first distance.

12. The image sensor of claim 11, wherein the diffusion grating includes a plurality of substantially parallel regions.

13. The image sensor of claim 11, comprising a plurality of microlenses on the optical filter.

14. A method, comprising:
manufacturing an optical filter intended to be arranged in front of an image sensor comprising a plurality of pixels, the method comprising the following successive steps:
depositing a first transparent layer coating a first mirror layer;
forming, in the first transparent layer, a diffraction grating and
depositing a second mirror layer coating the first transparent layer,
wherein the first transparent layer and the second and third mirror layers form, for each pixel, a resonant cavity, at least one of the cavities having a different thickness than another cavity.

15. The method according to claim 14, wherein forming the diffraction grating including a layer having a refraction index greater than that of the first transparent layer.

16. The method according to claim 14, wherein the first transparent layer is formed by successive depositions:
of a first portion of a first material, vertically extending from the first mirror layer to the diffraction grating; and
a second portion of a second material, different from the first material, the second portion vertically extending from the first portion to the second mirror layer.

17. The method according to claim 14, wherein the second mirror layer comprises at least two portions of different materials.
